(19) United States
(12) Patent Application Publication
(10) Pub. No.: US 2021/0093971 A1
(43) Pub. Date: Apr. 1, 2021

(54) METHOD, SYSTEM, AND NON-TRANSITORY COMPUTER-READABLE RECORD MEDIUM FOR PROVIDING CONTENT BASED ON USER RESPONSE

(71) Applicant: LINE Plus Corporation, Seongnam-si (KR)

(72) Inventors: Hyukjae JANG, Seongnam-si (KR); Donghyun KIM, Seongnam-si (KR); Hey Young YUN, Seongnam-si (KR); Jong Youn AHN, Seongnam-si (KR)

(73) Assignee: LINE Plus Corporation, Seongnam-si (KR)

(21) Appl. No.: 17/117,704

(22) Filed: Dec. 10, 2020

Related U.S. Application Data
(63) Continuation of application No. PCT/KR2018/006835, filed on Jun. 18, 2018.

(51) Int. Cl. A63F 13/537; G06F 3/0482; G06F 40/279; G06F 3/0484; G06Q 30/02; G06Q 50/00; G06Q 30/06; G06F 16/28

(52) U.S. Cl. CPC A63F 13/537; G06F 3/0482; G06F 40/279; G06F 3/0484; G06Q 2230/00; G06Q 30/0209; G06Q 50/01; G06Q 30/0631; G06F 16/285; G06Q 30/0204

(57) ABSTRACT

Disclosed is a content providing method including providing a first subset of content among a set of content to an electronic device of a user based on a request from the user for the set of content, generating a first interface space including assigning a first user group to the first interface space, the first user group being based on a first selection from the user from among a plurality of users requesting the set of content, and providing a second subset of content among the set of content based on a second selection received through the first interface space, the second subset of content being one of a plurality of follow-up subsets of content among the set of content, each of the plurality of follow-up subsets of content having a follow-up story corresponding to the first subset of content.

### CROSS-REFERENCE TO RELATED APPLICATION(S)

This U.S. non-provisional application is a continuation application of, and claims the benefit of priority under 35 U.S.C. § 365(c), to International Application No. PCT/KR2018/006835, filed Jun. 18, 2018, the entire contents of which are incorporated herein by reference in their entirety.

### TECHNICAL FIELD

At least one example embodiment relates to technology for providing content.

### RELATED ART

A rapid increase in users of high-speed communication networks enables the development of new services and diversification of service items through communication networks. A most general service among services using such a communication network may be called a video providing service.

For example, technology exists for providing a video link service that allows a user to view a linked video on the Internet using a mobile communication terminal.

### SUMMARY

At least one example embodiment may determine and provide a follow-up story of corresponding content according to responses of a plurality of users that request the content online.

According to an aspect of at least one example embodiment, there is provided a content providing method implemented by a computer system including processing circuitry, the content providing method including providing, by the processing circuitry, a first subset of content among a set of content to an electronic device of a user based on a request from the user for the set of content, generating, by the processing circuitry, a first interface space including assigning a first user group to the first interface space, the first user group being based on a first selection from the user from among a plurality of users requesting the set of content, and providing, by the processing circuitry, a second subset of content among the set of content based on a second selection received through the first interface space, the second subset of content being one of a plurality of follow-up subsets of content among the set of content, each of the plurality of follow-up subsets of content having a follow-up story corresponding to the first subset of content.

The set of content may include at least one branch point and the plurality of follow-up subsets of content are selectable based on a branch point among the at least one branch point of the first subset of content, and each of the plurality of follow-up subsets of content has a different follow-up story corresponding to the first subset of content.

The generating of the first interface space may include generating a user group list including a plurality of user groups by grouping the plurality of users into the plurality of user groups based on a plurality of criteria, and generating the first interface space including assigning the first user group to the first interface space based on the first selection of the first user group from the user group list.

The user group list may include a user group into which one or more of the plurality of users is grouped based on at least one of a social relationship, profile information, content preference information, or a content consumption path of the user.

The generating of the first interface space may generate the first interface space to include a selection function for selecting one of the plurality of follow-up subsets of content, and the second selection being received via the selection function.

The generating of the first interface space may generate the first interface space to include a voting function for selecting one of the plurality of follow-up subsets of content by a majority vote, and the second selection being received via the voting function.

The generating of the first interface space may generate the first interface space to provide a game, and the second selection is based on a reward acquired through the game.

The content providing method may further include recognizing, by the processing circuitry, a keyword or action in a conversation exchanged between users included in the first user group through the first interface space, wherein the second selection corresponds to the keyword or the action.

The content providing method may further include updating, by the processing circuitry, the first interface space to include a follow-up subset of content list that includes the plurality of follow-up subsets of content, the follow-up subset of content list including at least one of recommendation information or rating information for each of the plurality of follow-up subsets of content.

The content providing method may further include generating, by the processing circuitry, a second interface space including assigning a second user group to the second interface space, the second user group including users among the first user group consuming the second subset of content.

The content providing method may further include providing, by the processing circuitry, a content consumption path representing the first subset of content and the one of the plurality of follow-up subsets of content at the branch point of the first subset of content.

According to an aspect of at least one example embodiment, there is provided a non-transitory computer-readable record medium storing instructions that, when executed by processing circuitry, cause the processing circuitry to perform the content providing method.

According to an aspect of at least one example embodiment, there is provided a content providing system, the content providing system including processing circuitry configured to provide a first subset of content among a set of content to an electronic device of a user based on a request from the user for the set of content, generate a first interface space including assigning a first user group to the first interface space, the first user group being based on a first selection from the user from among a plurality of users requesting the set of content, and provide a second subset of content among the set of the content based on a second selection received through the first interface space, the second subset of content being one of a plurality of follow-up subsets of content among the set of content, each of the plurality of follow-up subsets of content having a follow-up story corresponding to the first subset of content.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

FIG. 1 is a diagram illustrating an example of a network environment according to at least one example embodiment;

FIG. 2 is a diagram illustrating an example of an electronic device and a server according to at least one example embodiment;

FIG. 3 is a diagram illustrating an example of components includable in a processor of a server according to at least one example embodiment;

FIG. 4 is a flowchart illustrating an example of a method performed by a server according to at least one example embodiment;

FIGS. 5 and 6 illustrate examples for describing a content type according to at least one example embodiment;

FIG. 7 illustrates an example of a process of selecting a user group according to at least one example embodiment;

FIG. 8 illustrates an example of a process of providing an interface space that includes a specific user group according to at least one example embodiment;

FIGS. 9 to 11 illustrate examples of a process of selecting follow-up partial content according to at least one example embodiment; and

FIG. 12 illustrates an example of a process of providing a content consumption path of a user according to at least one example embodiment.

### DETAILED DESCRIPTION

At least one example embodiment will be described in detail with reference to the accompanying drawings. At least one example embodiment, however, may be embodied in various different forms, and should not be construed as being limited to only the illustrated examples. Rather, the illustrated examples are provided so that this disclosure will be thorough and complete, and will fully convey the concepts of this disclosure to those skilled in the art. Accordingly, known processes, elements, and techniques, may not be described with respect to at least one example embodiment. Unless otherwise noted, like reference characters denote like elements throughout the attached drawings and written description, and thus descriptions will not be repeated.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, operations, elements, and/or components, but do not preclude the presence or addition of one or more other features, integers, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

Unless otherwise defined, all terms (including technical and scientific terms) used herein have the same meaning as, or a similar meaning to, that commonly understood by one of ordinary skill in the art to which at least one example embodiment belongs. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned herein. Examples of program code include both machine code produced by a compiler and higher level program code that is executed using an interpreter.

A hardware device, such as a computer processing device, may run an operating system (OS) and one or more software applications that run on the OS. The computer processing device also may access, store, manipulate, process, and create data in response to execution of the software. For simplicity, at least one example embodiment may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of at least one example embodiment may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, at least one example embodiment will be described with reference to the accompanying drawings.

At least one example embodiment relates to technology for providing content, and more particularly, to technology for determining and providing a follow-up story of corresponding content based on a user response to the content.

At least one example embodiment described herein may determine and provide a follow-up story of corresponding content based on a user response to the content and may achieve many advantages in terms of service quality, fun factor, convenience, and/or cost saving.

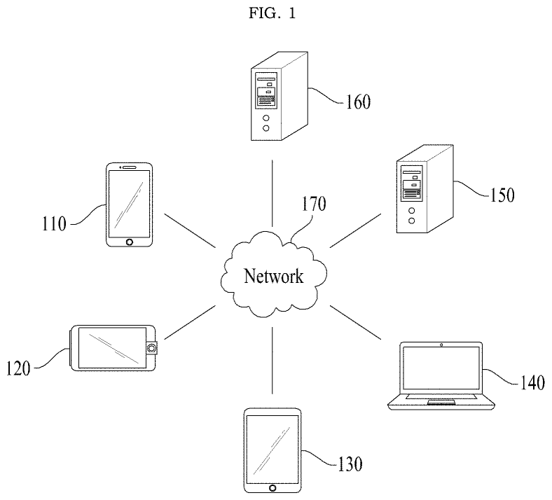

FIG. 1 illustrates an example of a network environment according to at least one example embodiment. Referring to FIG. 1, the network environment may include a plurality of electronic devices 110, 120, 130, and/or 140, a plurality of servers 150 and/or 160, and/or a network 170. FIG. 1 is provided as an example only. A number of electronic devices or a number of servers is not limited thereto.

Each of the plurality of electronic devices 110, 120, 130, and/or 140 may be a fixed terminal or a mobile terminal that is configured as a computer system. For example, the plurality of electronic devices 110, 120, 130, and/or 140 may be a smartphone, a mobile phone, a navigation device, a computer, a laptop computer, a digital broadcasting terminal, a personal digital assistant (PDA), a portable multimedia player (PMP), a tablet personal computer (PC), a game console, a wearable device, an Internet of things (IoT) device, a virtual reality (VR) device, an augmented reality (AR) device, and/or the like. For example, although FIG. 1 illustrates a shape of a smartphone as an example of the electronic device 110, the electronic device 110 used herein may refer to one of various types of physical computer systems capable of communicating with other electronic devices 120, 130, and 140, and/or the servers 150 and 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, a broadcasting network, a satellite network, etc.) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and Internet. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be configured as a computer apparatus or a plurality of computer apparatuses that provides an instruction, a code, a file, content, a service, etc., through communication with the plurality of electronic devices 110, 120, 130, and/or 140 over the network 170. For example, the server 150 may be a system that provides a first service to the plurality of electronic devices 110, 120, 130, and/or 140 connected over the network 170. The server 160 may be a system that provides a second service to the plurality of electronic devices 110, 120, 130, and/or 140 connected over the network 170. In detail, the server 150 may provide, as the first service, a service (e.g., a content providing service) intended (e.g., requested) by an application, the application may be a computer program installed and executed on the plurality of electronic devices 110, 120, 130, and/or 140. As another example, the server 160 may provide, as the second service, a service that distributes a file for installing and executing the application to the plurality of electronic devices 110, 120, 130, and/or 140.

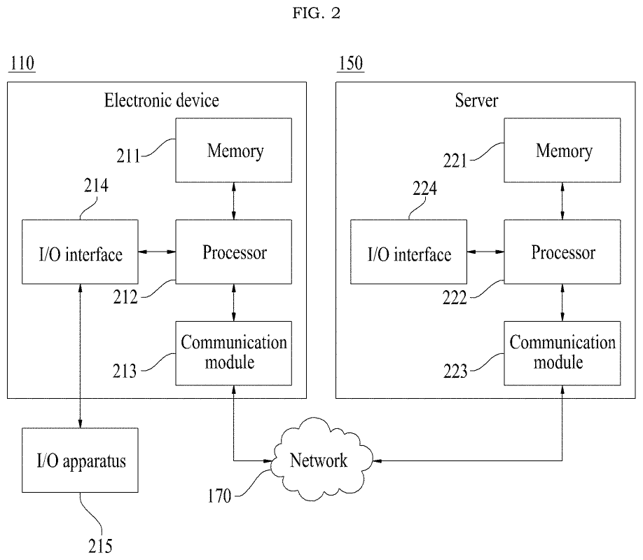

FIG. 2 is a block diagram illustrating an example of an electronic device and a server according to at least one example embodiment. Description is made using the electronic device 110 as an example of an electronic device and the server 150 as an example of a server with reference to FIG. 2. Also, the other electronic devices 120, 130, and/or 140, and/or the server 160, may have the same or a similar configuration as that of the electronic device 110 or the server 150.

Referring to FIG. 2, the electronic device 110 may include a memory 211, a processor 212, a communication module 213, and/or an input/output (I/O) interface 214, and the server 150 may include a memory 221, a processor 222, a communication module 223, and/or an I/O interface 224. The memory 211, 221 may include a permanent mass storage device, such as random access memory (RAM), a read only memory (ROM), a disk drive, a solid state drive (SSD), a flash memory, etc., as a non-transitory computer-readable record medium. The permanent mass storage device, such as ROM, a SSD, a flash memory, and/or a disk drive, may be included in the electronic device 110 or the server 150 as a permanent storage device separate from the memory 211, 221. Also, an OS and at least one program code, for example, a code for a browser installed and executed on the electronic device 110 or an application installed and executed on the electronic device 110 to provide a specific service, may be stored in the memory 211, 221.

Such software components may be loaded from another non-transitory computer-readable record medium separate from the memory 211, 221. The other non-transitory computer-readable record medium may include a non-transitory computer-readable record medium, for example, a floppy drive, a disk, a tape, a DVD/CD-ROM drive, a memory card, etc. According to at least one example embodiment, software components may be loaded to the memory 211, 221 through the communication module 213, 223, instead of the non-transitory computer-readable record medium. For example, at least one program may be loaded to the memory 211, 221 based on a computer program, for example, the application, installed by files provided over the network 170 from developers or a file distribution system, for example, the server 160, providing an installation file of the application.

The processor 212, 222 may be configured to process instructions of a computer program by performing basic arithmetic operations, logic operations, and I/O operations. The computer-readable instructions may be provided from the memory 211, 221 or the communication module 213, 223 to the processor 212, 222. For example, the processor 212, 222 may be configured to execute received instructions in response to the program code stored in the storage device, such as the memory 211, 221.

The communication module 213, 223 may provide a function for communication between the electronic device 110 and the server 150 over the network 170, and may provide a function for communication between the electronic device 110, and/or the server 150, and another electronic device, for example, the electronic device 120 or another server, for example, the server 160. For example, the processor 212 of the electronic device 110 may transfer a request created based on a program code stored in the storage device such as the memory 211, to the server 150 over the network 170 under control of the communication module 213. Inversely, a control signal, an instruction, content, a file, etc., provided under control of the processor 222 of the server 150 may be received at the electronic device 110 through the communication module 213 of the electronic device 110 by going through the communication module 223 and the network 170. For example, a control signal, an instruction, content, a file, etc., of the server 150 received through the communication module 213 may be transferred to the processor 212 or the memory 211, and content, a file, etc., may be stored in a storage medium, for example, the permanent storage device, further includable in the electronic device 110.

The I/O interface 214 may be a device used for interface with an I/O apparatus 215 (e.g., an input device and/or an output device). For example, an input device may include a device, such as a keyboard, a mouse, a microphone, a camera, etc., and an output device may include a device, such as a display, a speaker, a haptic feedback device, etc. As another example, the I/O interface 214 may be a device for interface with an apparatus in which an input function and an output function are integrated into a single function, such as a touchscreen. The I/O apparatus 215 may be configured as a single device with the electronic device 110. Also, the I/O interface 224 of the server 150 may be a device for interface with an apparatus (not shown) for input or output that may be connected to the server 150 or included in the server 150. In detail, when the processor 212 of the electronic device 110 processes an instruction of a computer program loaded to the memory 211, content or a service screen configured based on data provided from the server 150 or the electronic device 120 may be displayed on the display through the I/O interface 214.

According to at least one example embodiment, the electronic device 110 and the server 150 may include a number of components greater than or less than a number of components shown in FIG. 2. However, some components according to the related art are not illustrated in detail. For example, the electronic device 110 may include at least a portion of the I/O apparatus 215, or may further include other components, for example, a transceiver, a global positioning system (GPS) module, a camera, a variety of sensors, a database (DB), and the like. In detail, if the electronic device 110 is a smartphone, the electronic device 110 may be configured to further include a variety of components, for example, an acceleration sensor, a gyro sensor, a camera module, various physical buttons, a button using a touch panel, an I/O port, a vibrator for vibration, etc., which are generally included in the smartphone.

Hereinafter, at least one example embodiment of a method and system for providing content based on a user response are described.

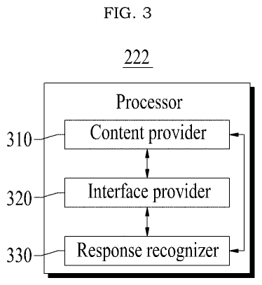

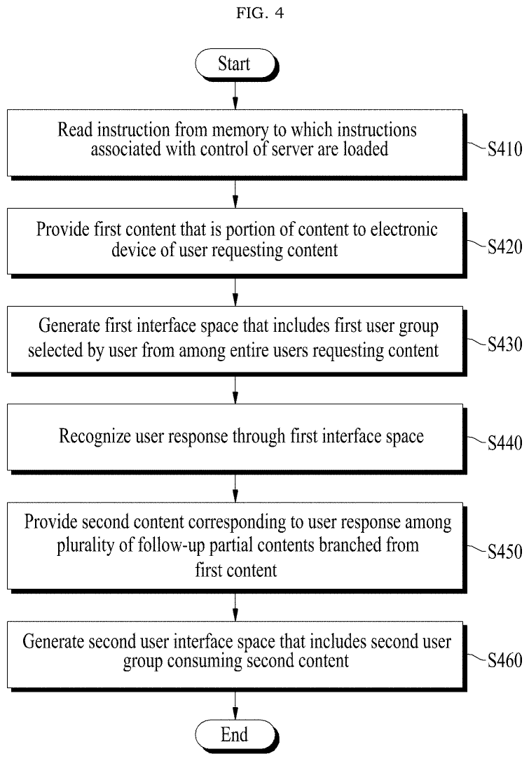

FIG. 3 is a diagram illustrating an example of components includable in a processor of a server according to at least one example embodiment, and FIG. 4 is a flowchart illustrating an example of a method performed by a server according to at least one example embodiment.

The server 150 according to at least one example embodiment serves as a platform to provide a content providing service to the plurality of electronic devices 110, 120, 130, and/or 140 that are clients. Here, content may inclusively represent content produced based on at least one of text, an image, a video, and/or audio, and may correspond to (e.g., be part of), for example, movie, a webtoon, a live quiz show, a game, and/or an e-book. In particular, the content providing service may be for content produced in a form in which a follow-up story that links to a previous story is branched into a plurality of different stories. That is, each piece of content may include at least one branch point and may include a plurality of follow-up partial contents separable based on each branch point. The content may include one of a plurality of follow-up partial contents that link to a previous story of previous partial content based on each branch point and have different follow-up stories.

The server 150 may perform a content providing method of FIG. 4 as a content providing server. To this end, referring to FIG. 3, the processor 222 of the server 150 may include a content provider 310, an interface provider 320, and/or a response recognizer 330. Depending on at least one example embodiment, the components of the processor 222 (e.g., the content provider 310, the interface provider 320 and/or the response recognizer 330) may be selectively included in or excluded from the processor 222. Also, depending on at least one example embodiment, the components of the processor 222 may be separated or merged for functional representation of the processor 222.

The processor 222 and the components of the processor 222 may control the server 150 to perform operations 5410 to 5460 included in the content providing method of FIG. 4. For example, the processor 222 and the components of the processor 222 may be configured to execute an instruction according to a code of at least one program, and/or a code of an OS, included in the memory 221.

Here, the components of the processor 222 may be representations of different functions of the processor 222 performed by the processor 222 in response to an instruction provided from a program code stored in the server 150. For example, the content provider 310 may be used as a functional representation of the processor 222 that controls the server 150 to provide content in response to a request from the electronic device 110, 120, 130, and/or 140.

Referring to FIG. 4, in operation 5410, the processor 222 may read an instruction from the memory 221 to which instructions associated with control of the server 150 are loaded. In this case, the read instruction may include an instruction for controlling the processor 222 to perform the following operations 5420 to 5460.

In operation 5420, the content provider 310 may provide first content that is a portion of content to the electronic device 110 of a user requesting the content (e.g., based on a request received from the user for the content). According to at least one example embodiment, the first content may be a first subset of content, and/or a first portion of content, among a set of content and/or a content presentation. Each set of content may refer to a discrete media presentation. According to at least one example embodiment, the first content may be text, an image, a video, and/or audio (e.g., corresponding files containing the respective content), and the set of content may be a movie, a webtoon, a live quiz show, a game, and/or an e-book (e.g., corresponding files containing the respective content). For example, the content provider 310 may batch-provide (e.g., broadcast, live-stream, etc.) the corresponding content to the entire users requesting the content in a real-time streaming manner at a preset or alternatively, given time. In particular, the content provider 310 may provide the content in a form in which a follow-up story that links to a previous story is branched into a plurality of different stories. Here, the content may include at least one branch point and a plurality of follow-up partial contents each having a follow-up story that links to a previous story as a portion of the corresponding content at each branch point. According to at least one example embodiment, each follow-up partial content may be a follow-up subset of content, and/or a follow-up portion of content, among a set of content and/or a content presentation. Each set of content may include at least one first content and a plurality of follow-up partial content. Each branch point may be associated with a plurality of follow-up partial contents. Each branch point may correspond to an end of an associated subset of content (e.g., the first content). According to at least one example embodiment, at least one follow-up partial content may include a branch point associated with a plurality of follow-up partial contents. For example, the set of content may include a follow-up partial content that links to a previous story of another follow-up partial content.

According to at least one example embodiment, the server 150 may store, maintain and/or update a plurality of sets of content in a database (e.g., in the memory 221). The database may store, maintain and/or update one or more branch points in association with each of the sets of content. For example, the database may store a time point (e.g., with respect to play time of the content), a page (e.g., a book page), a frame (e.g., a video frame), a scene, etc., corresponding to each branch point. The database may store, maintain and/or update a plurality of follow-up partial contents in association with each branch point.

In operation 5430, the interface provider 320 may generate and/or provide a first interface space that includes a first user group (e.g., a first group of users) selected by the user of the electronic device 110 from among user groups into which a plurality of users (e.g., the entire users) requesting the content are grouped based on various criteria. According to at least one example embodiment, generating the first interface space includes allocating, assigning and/or connecting the users of the first user group to the first interface space. Here, a user group may be determined based on user related information about the user of the electronic device 110, such as, for example, a social relationship (e.g., a friend), profile information (e.g., an age, a gender, and/or a location), content preference information, and/or a content branch history. The user related information may be information stored on the server 150, and/or the other server 160 interactable with the server 150, and may also be information acquirable by analyzing a consumption history and/or pattern of the user about the content provided from the server 150. The content preference information may include a taste (e.g., preference) or a genre of content generally used by the user, and the content branch history may refer to a flow history of each piece of content and may include a content path that includes partial content used by the user. The first interface space (may also be referred to herein as a “first user interface”) may refer to and/or include a chatroom joined by, occupied by, hosting, including, etc., the first user group, may include a chat function between users included in the first user group, and may include a function of sharing information associated with the first content or a user comment on the first content.

In operation 5440, the response recognizer 330 may receive, determine and/or recognize a user response (e.g., received through the first interface space) for determining second content (e.g., a second subset of content, and/or a second portion of content, among a set of content and/or a content presentation) that is one of a plurality of follow-up partial contents corresponding to a portion of the content having a follow-up history of the first content through the first interface space that includes the first user group selected by the user of the electronic device 110. In response to arrival at a branch point of the content, at a point in time at which transmission of the first content is completed, the response recognizer 330 may provide an interaction factor for recognizing the user response that determines the second content, such as a selection, a vote, a mission or a quest, and/or the like, through the first interface space. For example, the response recognizer 330 may provide a selection function on the plurality of follow-up partial contents through the first interface space, and may recognize a direct selection on the second content as the user response. As another example, the response recognizer 330 may provide a voting function enabling the users of the first user group to vote on the plurality of follow-up partial contents through the first interface space, and may recognize a voting result determined by majority vote in the first user group as the user response. As another example, the response recognizer 330 may provide a mission or a quest (e.g., an interactive game, competition, etc.) through the first interface space, and may recognize a reward acquired through the mission or the quest as the user response. Here, each user may be graded based on a content consumption performance, an overall service participation or reliability, and/or the like. Also, a selection right or a voting right (e.g., a selection ability or a voting ability) about the plurality of follow-up partial contents may be granted to at least one user among the first user group specified based on a grade, or a grade-by-grade weight may be differentially applied to the users in the first user group with respect to the reward acquired through the mission or the quest. In addition to using the interaction factor, if a predefined or alternatively, given keyword or action appears for each piece of follow-up partial content during a conversation exchanged between users through the first interface space, the response recognizer 330 may recognize the keyword or the action as the user response for determining the second content at the same time as, or contemporaneously to, content branching. According to at least one example embodiment, the database may store, maintain and/or update one or more keywords and/or actions in association with each follow-up partial content. According to at least one example embodiment, the response recognizer 330 may provide the selection function, the voting function, and/or the mission or quest by including one or more corresponding interfaces in the first interface space.

In operation 5450, the content provider 310 may provide the second content corresponding to the user response among the plurality of follow-up partial contents branched from the first content. For example, the content provider 310 may provide the second content directly selected by the user of the electronic device 110 to the electronic device 110. As another example, the content provider 310 may provide, to the electronic device 110, the second content determined by majority vote of the first user group selected by the user of the electronic device 110. Without being limited to the first user group, the content provider 310 may provide the second content determined by a voting result of the entire users requesting the content (e.g., all users consuming the respective set of content provided by the server 150 within a particular period). As another example, the content provider 310 may provide, to the electronic device 110, the second content according to the reward acquired through the mission or the quest in the first user group selected by the user of the electronic device 110. For example, if a total score acquired through the mission or the quest in the first user group reaches a target value, the content provider 310 may provide content A. Otherwise, the content provider 310 may provide content B. As another example, if a predefined or alternatively, given keyword or action appears in the contents of a conversation exchanged between users included in the first user group selected by the user of the electronic device 110, the content provider 310 may provide the second content corresponding to the keyword or the action to the electronic device 110 (e.g., by referring to the database). Therefore, the content provider 310 may determine and provide the second content based on a response of the user of the electronic device 110 or a response of the first user group selected by the user of the electronic device 110.

In operation 5460, the interface provider 320 may generate and/or provide a second interface space that includes a second user group consuming the second content of the same branch path or a similar branch path. According to at least one example embodiment, the second user group includes all users consuming the respective set of content provided by the server 150 within a particular period that selected the second content among the plurality of follow-up partial contents branched from the first content. The second user group may contain all, some or none of the user included in the first user group. According to at least one example embodiment, the second user group includes all users in the first user group in cases in which the second content is determined based on a response of the first user group (e.g., voting). According to at least one example embodiment, the second user group includes only the users in the first user group that selected the second content. The second interface space (may also be referred to herein as a “second user interface”) may refer to and/or include a chatroom joined by, occupied by, hosting, including, etc., the second user group, may include a chat function between users included in the second user group, and may also include a function of sharing information associated with the second content or a user comment on the second content. According to at least one example embodiment, generating the second interface space includes allocating, assigning and/or connecting the users of the second user group to the second interface space. Here, the second interface space may be a chatroom newly created as a space separate from the first interface space or may maintain the second user group consuming the follow-up partial content of the same story as, or a similar story to, the user of the electronic device 110, aside from a user consuming follow-up partial content of a story different from the user of the electronic device 110 in the first interface space. The interface provider 320 may provide a content path representing follow-up partial content, that is, second content consumed by the user of the electronic device 110 for each branch point of the corresponding content. Here, the interface provider 320 may distinguishably display the follow-up partial content consumed by the user of the electronic device 110 and the follow-up partial content not consumed by the user of the electronic device 110 in the entire branch paths of the content. According to at least one example embodiment, the server 150 may generate and/or provide a plurality of second interface spaces, each corresponding to a different respective follow-up partial content among the plurality of follow-up partial contents branched from the first content. Each of the plurality of second interface spaces may include a respective second user group among a plurality of second user groups that selected the respective follow-up partial content. The plurality of second user groups may include all users consuming the respective set of content provided by the server 150 within a particular period. According to at least one example embodiment, generating the plurality of second interface spaces includes allocating, assigning and/or connecting the users of each respective second user group among the plurality of second user groups to a corresponding second interface space among the plurality of second interface spaces.

Hereinafter, technology for providing content based on a user response is further described.

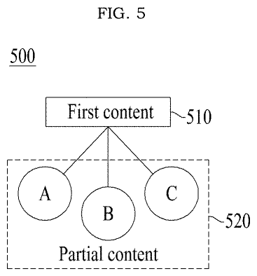

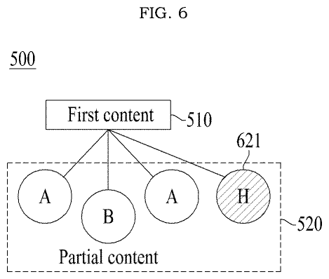

FIGS. 5 and 6 illustrate examples of describing a content type according to at least one example embodiment.

Referring to FIG. 5, content 500 may be in a form that a follow-up story that links to a previous story is branched into a plurality of different stories and may include first content 510 that is a portion of the content 500, and a plurality of follow-up partial contents 520 that are branched from the first content 510 and include different stories, for example, contents A, B, and C. Although the description is made based on the content 500 having a single branch point, the content 500 may include at least two branch points and may include a plurality of follow-up partial contents at each branch point.

Referring to FIG. 6, in addition to the contents A, B, and C directly open to the user during a selection process or a voting process, the follow-up partial contents 520 may also include hidden content 621 providable as an undisclosed hidden path, based on a user response, such as, for example, a predefined or alternatively, given mission, quest, and/or keyword.

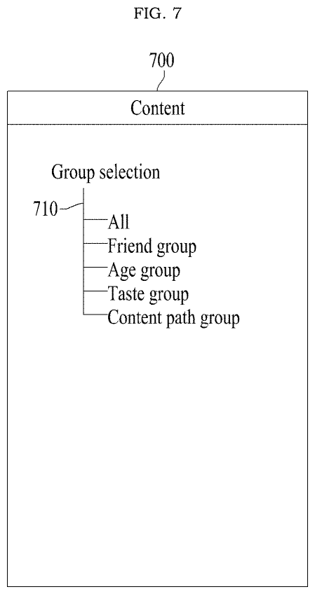

FIG. 7 illustrates an example of describing a process of selecting a user group according to at least one example embodiment.

Referring to FIG. 7, the interface provider 320 may provide a user group list 710 in which the entire users requesting content (e.g., all users requesting a particular set of content within a particular period of time) are grouped based on various criteria through a user group section screen 700. According to at least one example embodiment, the interface provider 320 may generate the user group list 710 by grouping the entire users requesting content based on the various criteria. A user group may be determined based on at least one of a social relationship, profile information, content preference information, and/or a content branch history. For example, the user group list 710 may include the entire users requesting the content, a friend group including users having a friend relationship, an age group including users of similar age, a taste group including users having the same or similar taste for the content, and/or a content path group of users using the same content path, or a similar content path, for previously consumed partial content.

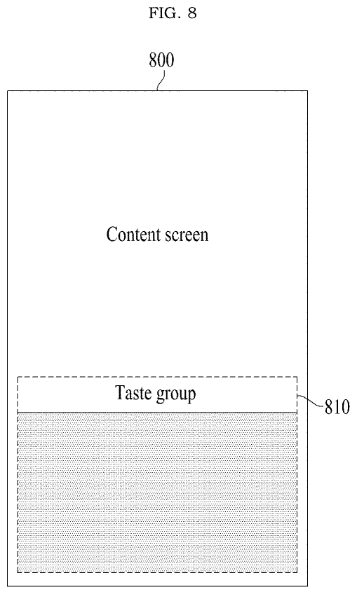

FIG. 8 illustrates an example a process of providing an interface space that includes a specific user group according to at least one example embodiment.

Referring to FIG. 8, in response to a selection from the user of the electronic device 110 on a specific group, for example, a taste group in the user group list 710 displayed on the user group selection screen 700 of FIG. 7, the interface provider 320 may display a group chatroom 810 that includes users having a taste the same as, or similar to, that of the user of the electronic device 110 as an interface space capable of sharing information or a user comment on the first content on a content screen 800 on which the first content is displayed. According to at least one example embodiment, the interface space includes the content screen 800, the group chatroom 810 and/or an interface that enables the users of the taste group and the user of the electronic device 110 to share information and/or user comments with one another.

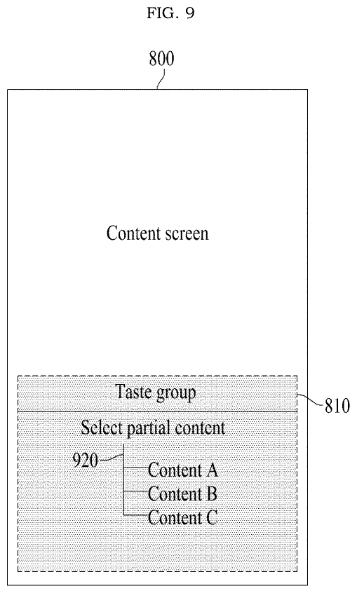

FIGS. 9 to 11 illustrate examples of a process of selecting follow-up partial content according to at least one example embodiment.

Referring to FIG. 9, in response to arrival at a branch point of content, for example, in response to transmission of the first content being completed, the response recognizer 330 may provide a content list 920 that includes follow-up partial contents selectable at the corresponding branch point through the group chatroom 810 and may receive, from the user of the electronic device 110, information representing second content that is one of the follow-up partial contents is selected from the content list 920. According to at least one example embodiment, the response recognizer 330 may provide the content list 920 by updating the first interface space to include the content list 920.

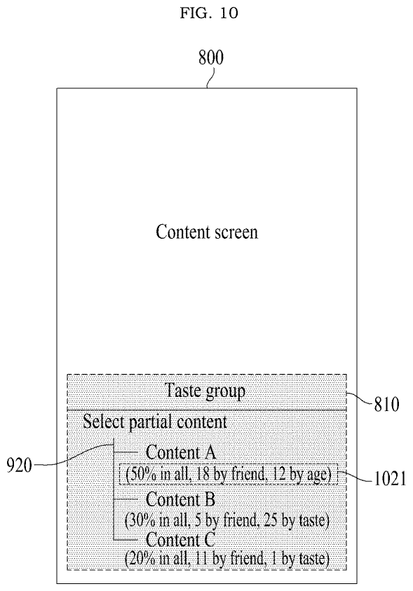

Referring to FIG. 10, the response recognizer 330 may also provide recommendation information 1021 for each of the follow-up partial contents included in the content list 920. For example, the recommendation information 1021 may include a weight of selection by the entire users requesting content, a weight of selection by users having a friend relationship, a weight of selection by users having the same or similar taste, and/or may include ranking information based on one or more of the weights. The user of the electronic device 110 may determine the second content by considering the recommendation information 1021 in a process of selecting the follow-up partial content.

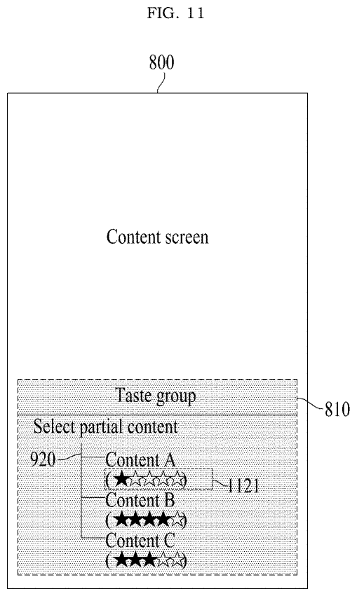

Referring to FIG. 11, the response recognizer 330 may also provide rating information 1121 for each of the follow-up partial contents included in the content list 920. Users consuming content may rate individual content consumed by the users or each of partial contents included in the individual content according to a branch path. The response recognizer 330 may provide the rating information 1121 by users for each of the follow-up partial contents included in the content list 920. The user of the electronic device 110 may determine the second content by considering the rating information 1121 in a process of selecting the corresponding follow-up partial content. A content rating assigned by the user may be used to analyze content preference information, such as a user taste for the content.

In addition to a method that allows an individual user to directly select second content, the recommendation information 1021 and/or the rating information 1121 may be provided with the content list 920 and voting may be allowed, enabled, etc., in a process of determining the second content by vote.

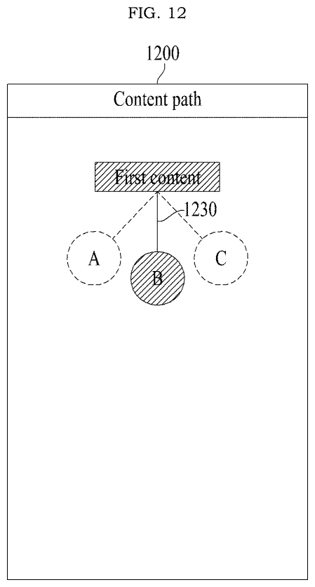

FIG. 12 illustrates an example of describing a process of providing a content consumption path of a user according to at least one example embodiment.

Referring to FIG. 12, the interface provider 320 may display a content consumption path 1230 representing which partial content is consumed by the user of the electronic device 110 at each branch point of content through a content path screen 1200. The interface provider 320 may provide the content consumption path 1230 of the user that consumes by the present time at each branch point. Here, the interface provider 320 may differently display the content consumption path 1230 of the user to be distinguished from remaining branch paths in the entire branch paths of the content. For example, although the user of the electronic device 110 consumes content B after consuming the first content, the user may not consume contents A and C. According to at least one example embodiment, the server 150 may not provide the user of the electronic device 110 contents A and C if the user consumes content B. In this case, the interface provider 320 may display the first content and the content B to be distinguished from the contents A and C.

According to at least one example embodiment, with respect to content of which a follow-up story that links to a previous story is branched into a plurality of different stories, it is possible to determine and provide a follow-up story of the corresponding content based on responses of a plurality of users online. According to at least one example embodiment, one or more interface spaces are provided that enable selectable and/or personalized follow-up stories of corresponding content.

According to at least one example embodiment, operations described herein as being performed by the electronic device 110, the processor 212, the server 150, the processor 222, the content provider 310, the interface provider 320 and/or the response recognizer 330 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The systems or apparatuses described above may be implemented using hardware components, software components, and/or a combination thereof. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For simplicity, the description of a processing device is used as singular; however, one skilled in the art will appreciate that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and/or data may be embodied permanently or temporarily in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable storage mediums.

The above-described methods according to at least one example embodiment may be recorded in non-transitory computer-readable media including program instructions to implement various operations of the above-described examples. The media may also include, alone or in combination with the program instructions, data files, data structures, and the like. The media may continuously store a program executable by a computer or may temporarily store or the program for execution or download. Also, the media may be various types of recording devices or storage devices in which a single piece or a plurality of pieces of hardware may be distributed over a network without being limited to a medium directly connected to a computer system. Examples of the media may include magnetic media such as hard disks, floppy disks, and magnetic tapes; optical media such as CD-ROM discs and DVDs; magneto-optical media such as floptical disks; and hardware devices that are specially configured to store and perform program instructions, such as read-only memory (ROM), random access memory (RAM), flash memory, and the like. Examples of other media may include recording media and storage media managed at Appstore that distributes applications or sites and servers that supply and distribute various types of software. Examples of program instructions include both machine code, such as produced by a compiler, and files containing higher level code that may be executed by the computer using an interpreter.

While this disclosure includes at least one example embodiment, it will be apparent to one of ordinary skill in the art that various alterations and modifications in form and details may be made without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

What is claimed is:

1. A content providing method implemented by a computer system including processing circuitry, the content providing method comprising:
providing, by the processing circuitry, a first subset of content among a set of content to an electronic device of a user based on a request from the user for the set of content;
generating, by the processing circuitry, a first interface space including assigning a first user group to the first interface space, the first user group being based on a first selection from the user from among a plurality of users requesting the set of content; and
providing, by the processing circuitry, a second subset of content among the set of content based on a second selection received through the first interface space, the second subset of content being one of a plurality of follow-up subsets of content among the set of content, each of the plurality of follow-up subsets of content having a follow-up story corresponding to the first subset of content.

2. The content providing method of claim 1, wherein
the set of content comprises at least one branch point and the plurality of follow-up subsets of content are selectable based on a branch point among the at least one branch point of the first subset of content; and
each of the plurality of follow-up subsets of content has a different follow-up story corresponding to the first subset of content.

3. The content providing method of claim 1, wherein the generating the first interface space comprises:
generating a user group list comprising a plurality of user groups by grouping the plurality of users into the plurality of user groups based on a plurality of criteria; and
generating the first interface space including assigning the first user group to the first interface space based on the first selection of the first user group from the user group list.

4. The content providing method of claim 3, wherein the user group list comprises a user group into which one or more of the plurality of users is grouped based on at least one of a social relationship, profile information, content preference information, or a content consumption path of the user.

5. The content providing method of claim 1, wherein
the generating the first interface space generates the first interface space to include a selection function for selecting one of the plurality of follow-up subsets of content; and
the second selection being received via the selection function.

6. The content providing method of claim 1, wherein
the generating the first interface space generates the first interface space to include a voting function for selecting one of the plurality of follow-up subsets of content by a majority vote; and
the second selection being received via the voting function.

7. The content providing method of claim 1, wherein
the generating the first interface space generates the first interface space to provide a game; and
the second selection is based on a reward acquired through the game.

8. The content providing method of claim 1, further comprising:
recognizing, by the processing circuitry, a keyword or action in a conversation exchanged between users included in the first user group through the first interface space,
wherein the second selection corresponds to the keyword or the action.

9. The content providing method of claim 1, further comprising:
updating, by the processing circuitry, the first interface space to include a follow-up subset of content list that includes the plurality of follow-up subsets of content, the follow-up subset of content list including at least one of recommendation information or rating information for each of the plurality of follow-up subsets of content.

10. The content providing method of claim 1, further comprising:
generating, by the processing circuitry, a second interface space including assigning a second user group to the second interface space, the second user group including users among the first user group consuming the second subset of content.

11. The content providing method of claim 2, further comprising:
providing, by the processing circuitry, a content consumption path representing the first subset of content and the one of the plurality of follow-up subsets of content at the branch point of the first subset of content.

12. A non-transitory computer-readable record medium storing instructions that, when executed by the processing circuitry, cause the processing circuitry to perform the content providing method of claim 1.

13. A content providing system implemented, comprising:
processing circuitry configured to
provide a first subset of content among a set of content to an electronic device of a user based on a request from the user for the set of content,
generate a first interface space including assigning a first user group to the first interface space, the first user group being based on a first selection from the user from among a plurality of users requesting the set of content, and
provide a second subset of content among the set of the content based on a second selection received through the first interface space, the second subset of content being one of a plurality of follow-up subsets of content among the set of content, each of the plurality of follow-up subsets of content having a follow-up story corresponding to the first subset of content.

14. The content providing system of claim 13, wherein
the set of content comprises at least one branch point and the plurality of follow-up subsets of content are selectable based on a branch point; and
each of the plurality of follow-up subsets of content has a different follow-up story corresponding to the first subset of content.

15. The content providing system of claim 13, wherein the processing circuitry is configured to:
generate a user group list comprising a plurality of user groups by grouping the plurality of users into the plurality of user groups based on a plurality of criteria; and
generate the first interface space including assigning the first user group to the first interface space based on the first selection of the first user group from the user group list.

16. The content providing system of claim 13, wherein
the processing circuitry is configured to generate the first interface space to include a selection function for selecting one of the plurality of follow-up subsets of content; and
the second selection being received via the selection function.

17. The content providing system of claim 13, wherein
the processing circuitry is configured to generate the first interface space to include a voting function for selecting one of the plurality of follow-up subsets of content by majority vote; and
the second selection being received via the voting function.

18. The content providing system of claim 13, wherein
the processing circuitry is configured to generate the first interface space to provide a game; and
the second selection is based on a reward acquired through game.

19. The content providing system of claim 13, wherein
the processing circuitry is configured to recognize a keyword or action in a conversation exchanged between users included in the first user group through the first interface space; and
the second selection corresponds to the keyword or the action.

20. The content providing system of claim 14, wherein the processing circuitry is configured to provide a content consumption path representing the first subset of content and the one of the plurality of follow-up subsets of content at the branch point of the first subset of content.
